(19) United States
(12) Patent Application Publication
(10) Pub. No.: US 2015/0318163 A1
(43) Pub. Date: Nov. 5, 2015

(54) OXIDIZED ELECTRODES AS OXYGEN DISPENSERS IN METAL HALIDE LAMPS

(71) Applicant: General Electric Company, Schenectady, NY (US)

(72) Inventors: Agoston BOROCZKI, Budapest (HU); Peter HORVATH, Budapest (HU); Laszlo UGROSDY, Budapest (HU); Sandor SEBOK, Budapest (HU); Akos PETER, Budapest (HU)

(73) Assignee: General Electric Company, Schenectady, NY (US)

(21) Appl. No.: 14/267,381

(22) Filed: May 1, 2014

(51) Int. Cl. H01J 61/06; C25D 11/26

(52) U.S. Cl. CPC H01J 61/06; C25D 11/26

(57) ABSTRACT

An electrode for dosing oxygen into a metal halide lamp, where the electrode supplies oxygen during lamp operation in an amount effective to maintain a wall cleaning tungsten halogen chemical cycle. Use of the oxygen dosing electrode increases the lumen maintenance of the lamp to 80% or higher at 6000 hours. A method for making an oxidized electrode for use as an oxygen dispenser into the discharge vessel of a metal halide lamp is also provided.

### FIELD OF THE INVENTION

The subject matter disclosed herein relates generally to high intensity discharge lamps. More particularly, the subject matter disclosed herein relates to prolonging the lumen maintenance of metal halide lamps using a wall cleaning tungsten oxy-halogen chemical cycle where the source of oxygen is a metal-oxide layer on the electrode surface.

### BACKGROUND OF THE INVENTION

Metal halide discharge lamps produce light by ionizing a vaporous fill material, such as a mixture of rare gases or mercury and metal halides with an electric arc passing between two electrodes. The electrodes and the fill material are sealed within a translucent or transparent discharge vessel that maintains the pressure of the energized fill material and allows the emitted light to pass through it. The ionizable fill material emits a desired spectral energy distribution in response to being excited by the electric arc. For example, metal halides provide spectral energy distributions that offer a broad choice of light properties, e.g. color temperatures, color renderings, and luminous efficacies.

Ceramic discharge chambers for metal halide lamps have been developed to operate at higher temperatures for improved color renderings and luminous efficacies, while significantly reducing reactions with the fill material, therefore improving color stability over time. Such lamps with ceramic discharge chambers have been termed “CMH” lamps. CMH lamps are widely used because they have higher efficiency (80 to 120 lm/W) and excellent color rendering (80 to 95). This is economically and environmentally beneficial. Quartz discharge chambers are also used; these lamps are called quartz metal halide lamps.

These metal halide lamps, however, often experience reduced light output over time due to darkening of the inside of the discharge chamber walls. This darkening is due to tungsten being evaporated from the tip of the electrode during operation and deposited on the inside wall, blocking light. Several methods have been proposed to address this issue.

In one method developed for tungsten-halogen lamps in the 1950s, a wall cleaning tungsten halogen chemical cycle is used. At the temperature of the wall, tungsten atoms react with gaseous halogen vapor and trace levels of oxygen to form stable tungsten oxyhalides. The tungsten oxyhalides diffuse back to the central region surrounding the electrode (and arc) where they decompose at the high temperature, leaving elemental tungsten re-deposited on the electrode. Once free of combined tungsten, the oxygen and halide compounds diffuse back to the wall to repeat the regenerative cycle. The diffusion process is driven by the concentration gradients in the discharge chamber that are maintained by the continuous formation of tungsten oxyhalides at the wall and decomposition at the arc (and electrode) temperature.

This wall-cleaning tungsten halogen chemical cycle only operates in a rather narrow oxygen concentration range. If the oxygen concentration is too low, the cycle is not efficient, and more tungsten is evaporated than is transported back to the electrode tip. If the oxygen concentration is too high, then the cooler parts of the electrode assembly can be attacked by the parasitic tungsten-oxyhalide cycle, leading to rapid deterioration of the electrode. Moreover, this method requires the deliberate addition of oxygen to the discharge vessel. Metal halide lamps are manufactured in very clean environments and oxygen is not incorporated into the discharge vessel upon manufacture. Metal halide lamps must be deliberately dosed with oxygen in order to employ a wall cleaning tungsten halogen cycle.

Accordingly, it is important to have accurate oxygen dosing in metal halide lamps. The method of adding oxygen should provide a precise amount of oxygen and also should be compatible with the standard manufacturing processes for metal halide lamps.

### SUMMARY OF THE EMBODIMENTS

In at least one aspect, the present disclosure provides an electrode for dosing oxygen into a metal halide lamp, where the electrode supplies oxygen during lamp operation in an amount effective to maintain a wall cleaning tungsten halogen chemical cycle.

In at least another aspect the electrode increases the lumen maintenance of the lamp to 80% or higher at 6000 hours.

In at least another aspect, the present disclosure provides a method for making an oxidized electrode for use as an oxygen dispenser into the discharge vessel of a metal halide lamp.

“Lumen maintenance” refers to a comparison of the amount of light produced from a light source or from a luminaire when it is new to the amount of light output at a specific time in the future. For instance, if a luminaire produced 1000 lumens of light when it was new and now produces 700 lumens of light after 30,000 hours, then it has a lumen maintenance of 70% at 30,000 hours. High intensity discharge lamps often need some time to reach stable color and lumen output therefore initial performance is usually measured after some stabilization time, in the case of ceramic metal halide lamps after 100 hours. In this case lumen maintenance compares the lumen output at any given time to the initial lumen output at 100 hours.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS

FIG. 1 is a schematic of an embodiment of a CMH lamp in accordance with the present disclosure.

FIG. 2 is a schematic of an embodiment of a discharge vessel in accordance with the present disclosure.

FIG. 3 illustrates a method of oxidizing an electrode in accordance with the present disclosure.

FIG. 4 illustrates a method of assembling a discharge chamber having an oxidized electrode in accordance with the present disclosure.

FIG. 5 illustrates relative lumen maintenance of CMH lamps with electrochemically oxidized electrodes. The solid line is oxygen-free; the dotted and dashed lines are oxidized electrodes. The oxidized electrode part (W or Mo) and the total charge per electrode are as shown in the legend.

The present disclosure may take form in various components and arrangements of components, and in various process operations and arrangements of process operations. The present disclosure is illustrated in the accompanying drawings, throughout which like reference numerals may indicate corresponding or similar parts in the various figures. The drawings are only for purposes of illustrating preferred embodiments and are not to be construed as limiting the disclosure. Given the following enabling description of the drawings, the novel aspects of the present disclosure should become evident to a person of ordinary skill in the art.

### DETAILED DESCRIPTION OF EMBODIMENTS OF THE INVENTION

The following detailed description is merely exemplary in nature and is not intended to limit the applications and uses disclosed herein. Further, there is no intention to be bound by any theory presented in the preceding background or summary or the following detailed description. While embodiments of the present technology are described herein primarily in connection with ceramic and quartz metal halide lamps utilizing tungsten electrodes it should be understood that the invention is applicable to other types of high intensity discharge lamps.

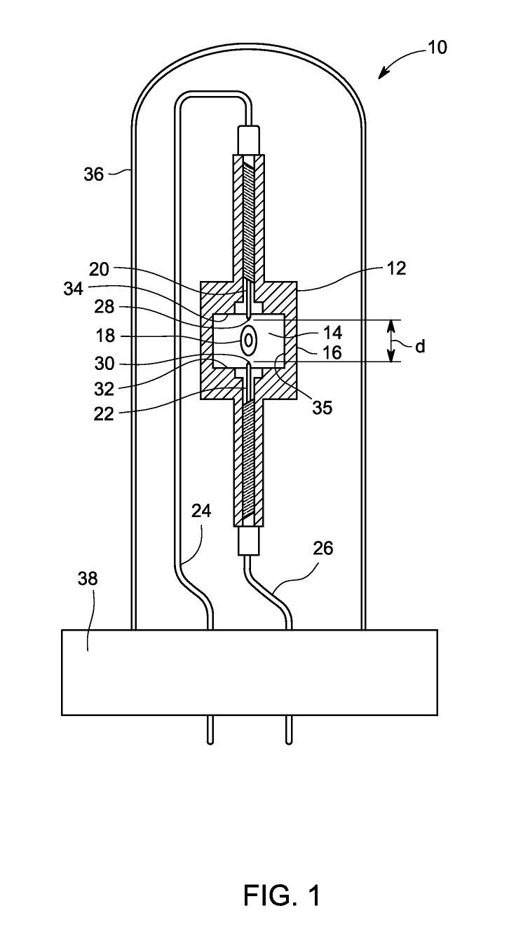

FIG. 1 illustrates a cross-sectional view of an exemplary ceramic metal halide lamp 10. The lamp includes a discharge vessel or arc tube 12, which defines an interior chamber 14. The discharge vessel 12 has a wall 16, which may be formed of a ceramic material, such as alumina. An ionizable fill 18 is sealed in the interior chamber 14.

Tungsten electrodes 20, 22 are positioned at opposite ends of the discharge vessel so as to energize the fill when an electric current is applied thereto. The two electrodes 20 and 22 are typically fed with an alternating electric current via conductors 24, 26 (e.g., from a ballast, not shown). Tips 28, 30 of the electrodes extend interiorly of a respective interior end wall 32, 34 of the wall 16 and are spaced by an arc gap of dimension d.

While the electrodes 20, 22 may be formed from pure tungsten, e.g., greater than 99% pure tungsten, it is also contemplated that the electrodes may have a lower tungsten content, e.g., may comprise at least 50% tungsten.

The discharge vessel 12 is surrounded by an outer bulb 36 that is provided with a lamp cap 38 at one end, through which the lamp is connected with a source of power (not shown). The bulb 36 may be formed of glass or other suitable material. The lighting assembly 10 also includes a ballast (not shown), which acts as a starter when the lamp is switched on. The ballast is located in a circuit that includes the lamp and the power source. The space between the arc tube and outer bulb may be evacuated. Optionally a shroud (not shown) formed from quartz or other suitable material, surrounds or partially surrounds the arc tube to contain possible arc tube fragments in the event of an arc tube rupture.

In operation, the electrodes 20, 22 produce an arc between tips 28, 30 of the electrodes, which ionizes the fill to produce a plasma in the discharge space. The emission characteristics of the light produced are dependent, primarily, upon the constituents of the fill material and the geometry of the chamber. In the following description of the fill, the amounts of the components refer to the amounts initially sealed in the discharge vessel, i.e., before operation of the lamp, unless otherwise noted.

The ionizable fill 18 includes a buffer gas, usually mercury (Hg), and a mixture of metal-halide compounds. The buffer gas may be an inert gas, such as neon, argon, krypton, xenon, or a combination thereof, and may be present in the fill at from about 5-20 micromoles per cubic centimeter (μmol/cm³) of the interior chamber 14. The buffer gas may also function as a starting gas for maintaining glow discharge during the early stages of lamp operation. In one embodiment, suited to CMH lamps, the lamp is filled with Ar. In another embodiment, Xe or Ar with a small addition of Kr⁸⁵ is used. The radioactive Kr⁸⁵ provides ionization that assists in starting the lamp. The cold fill pressure may be about 60-300 Torr, although higher cold fill pressures are not excluded. In one embodiment, a cold fill pressure of at least about 120 Torr is used. In another embodiment, the cold fill pressure is up to about 240 Torr. Too high a pressure may compromise starting. Too low a pressure can lead to increased lumen depreciation over life. During lamp operation, the pressure of the buffer gas may be at least about 1 atm.

The mercury dose may be present at from about 3 to 60 mg/cm³ of the arc tube volume. In one embodiment, the mercury dose is about 20 mg/cm³. The mercury weight is adjusted to provide the desired arc tube operating voltage (Vop) for drawing power from the selected ballast. In an alternative embodiment, the lamp fill is mercury-free.

The halide component may be present at from about 20 to about 80 mg/cm³ of arc tube volume, e.g., about 30-60 mg/cm³. A ratio of halide dose to mercury can be, for example, from about 1:3 to about 15:1, expressed by weight. The halide(s) in the halide component can each be selected from chlorides, bromides, iodides and combinations thereof. In one embodiment, the halides are all iodides. Iodides tend to provide longer lamp life, as corrosion of the arc tube and/or electrodes is lower with iodide components in the fill than with otherwise similar chloride or bromide components. The halide compounds usually will represent stoichiometric relationships.

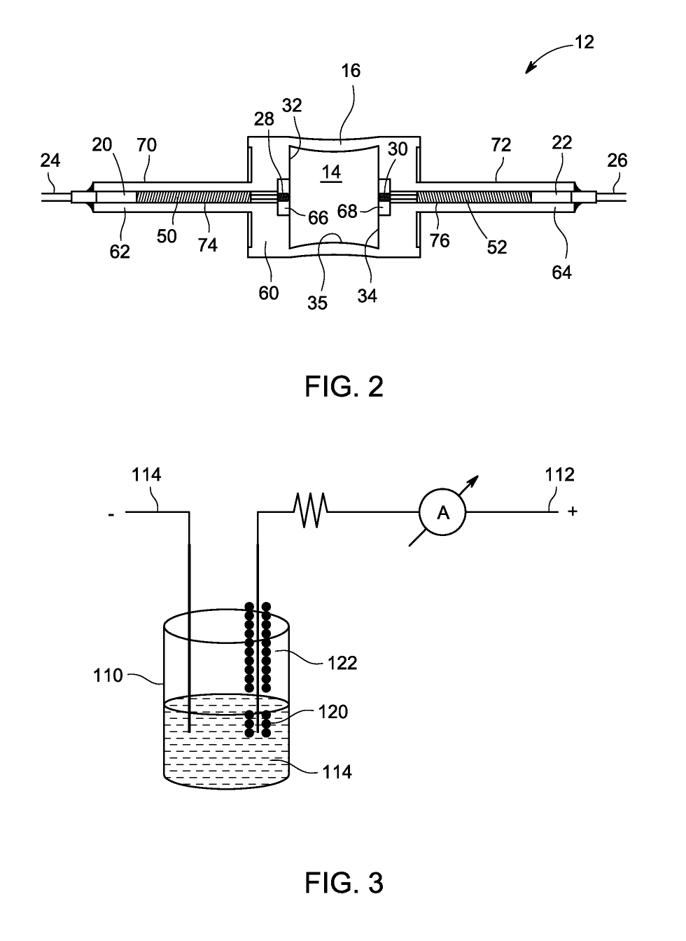

FIG. 2 illustrates an exemplary embodiment of a discharge vessel or arc tube 12 in greater detail. The electrodes 20, 22 include leadwires or conductors 24, 26 made out of niobium (Nb), tungsten electrode tips 28, 30, and a middle region comprising a molybdenum (Mb) core wire and a molybdenum overwind forming a coil 50, 52. The tungsten electrode tips 28, 30 extend into the interior chamber 14 past walls 32, 34.

The exemplary discharge vessel 12 includes a hollow cylindrical portion or barrel 60 and two opposed hollow legs 62, 64. The barrel 60 and legs 62, 64 may be formed from separate components that are fused together during formation of the lamp. The two legs 62, 64 may be similarly shaped and each includes a cone or base portion 66, 68, from which respective hollow leg portions or tubes 70, 72 extend outwardly.

The electrodes 20, 22 are seated in bores 74, 76 within their respective leg portions 70, 72 and extend into the cylindrical base portions 66, 68. The discharge chamber 14 is sealed at the ends of the leg portions 70, 72 by seals (not shown) to create a gas-tight discharge space.

When the lamp 10 is powered, indicating a flow of current to the lamp, a voltage difference is created across the two electrodes. This voltage difference causes an arc across the gap between the tips 28, 30 of the electrodes. The arc results in a plasma discharge in the region between the electrode tips 28, 30. Visible light is generated and passes out of the chamber 14 and through the wall 16.

Electrodes 20, 22 become heated during lamp operation and tungsten tends to vaporize from the tips 28, 30. In order to minimize deposition of tungsten on the interior surface 35 of wall 16, a wall cleaning tungsten halogen chemical cycle is employed.

Employment of a wall cleaning tungsten halogen cycle requires the presence of a small amount of oxygen inside the discharge vessel. This oxygen is provided from a part of the electrode that is oxidized prior to assembly of the discharge vessel. Since the discharge vessel is assembled in an oxygen free environment, this method allows for the introduction of a precise amount of oxygen into the discharge vessel.

The tungsten tip and/or the molybdenum part of the electrode is oxidized and then the discharge vessel is assembled in a standard fashion. During the very first ignition of the lamp, the electrode heats up well above 1300 C, causing tungsten-oxide and/or molybdenum-oxide on the oxidized electrode to evaporate and redeposit on the discharge vessel interior wall 35. These oxides then react with free halogens in the discharge vessel 14, and form tungsten-oxyhalides or molybdenum-oxyhalides.

This wall-cleaning tungsten halogen chemical cycle only operates in a rather narrow oxygen concentration range. If the oxygen concentration is too low, the cycle is not efficient, and more tungsten is evaporated than is transported back to the electrode tip. If the oxygen concentration is too high, then the cooler parts of the electrode assembly can be attacked by the parasitic tungsten-oxyhalide cycle, leading to rapid deterioration of the electrode.

The target oxygen density necessary for optimal lumen maintenance is between 0.5 and 5 μmol/cm³ per arc tube volume. For example, the volume of the 35 W arc tube used for the example below was 0.13 cm³ and the quantity of elemental oxygen in the arc tube was 0.28 μmol (for a density of 2.15 μmol/cm³). This oxygen density can be achieved by providing 0.093 μmol of WO₃ or MoO₃ on the electrode.

The desired oxygen dosage depends on several factors, including the desired lumen maintenance; the metal halide quantity and type; the arc tube operating temperature; the electrode design; and the lamp wattage. In general, higher lumen maintenance can be achieved by dosing more oxygen into the lamp, however higher oxygen densities (in particular above 5 μmol/cm³) may cause parasitic tungsten-oxyhalide cycle that attacks the electrode shank and eventually cuts the electrode tip off the shank. It was found that at higher metal-halide weight higher oxygen quantity is necessary to achieve the same lumen maintenance. The metal-halide dose weight of the lamps used in the example discussed below were 4.5 mg; for higher metal-halide weight proportionally more oxygen is required to achieve similar lumen maintenance. Higher arc tube temperature due to high wall loading or increased back-heating of the arc tube by an external reflector such as in PAR or MR16 lamps also requires higher oxygen level to achieve the same lumen maintenance. Due to this effect up to 30% more oxygen is required in an MR16 lamp than in a G12 lamp with an otherwise similar arc tube design.

Generally, dosing oxygen into the metal halide lamp as provided herein may improve lumen maintenance to as high as 90% at 6000 hours. In the example discussed below lumen maintenance of 35 W CMH lamps built with oxidized molybdenum part reached 93% at 6000 hours, whereas lamps built with oxidized tungsten part achieved 85%. In comparison, lamps built with exactly the same parameters but without additional source of oxygen reached only 67%.

FIG. 3 is a schematic of a method of electrochemically oxidizing an electrode. The electrode assembly of the CMH lamp is first cleaned in the usual way, i.e. by using heat treatment in an oxygen furnace and in a vacuum furnace. The electrode is then oxidized (by electrochemical oxidation as shown here). The electrode 100 is placed into an electrochemical cell 110, and is connected to the positive output terminal (anode) 112 of a DC power supply (not shown). Electric current is passed through the electrochemical cell 110 and elemental oxygen produced from the aqueous solution (electrolyte) 114 of the cell 110 readily reacts with the tungsten electrode tip 120 and/or the molybdenum coil 122 of the electrode assembly. The level of the electrolyte or degree to which the electrode is submerged will determine the part of the electrode which is oxidized.

If both the Mo overwind and the core are submerged and oxidized then the W tip is also immersed in the electrolyte and is also oxidized to a limited extent. However, since WO₃ forms an insulating layer whereas MoO₃ does not, most of the current flows through the Mo part and mostly MoO₃ is produced.

The total oxidation (and thus oxygen later released from the electrode) formed by this process can accurately be set by adjusting electric current, voltage, and time of the electrochemical process, as well as the chemical composition (mainly, acidic property, i.e. “pH” value) of the electrolyte in the cell. If both electrodes are oxidized, the total charge required to produce a predetermined oxygen quantity on the electrode can be calculated from Faraday's law as Q[C]=F*n(O) [mol], where F (the Faraday constant) is 96485 C/mol and n(O) is the predetermined elemental oxygen quantity. In the example discussed below, both the tungsten and molybdenum parts of the electrode were immersed in the electrolyte and 5 V was applied to the electrochemical cell and a 10 kOhm series resistor. 0.4 mA constant current was flowing through the cell for 67 s giving a total charge of 27 mC that produces 0.093 μmol of WO₃ or MoO₃ that in turn releases 0.28 μmol elemental oxygen into the arc tube.

In general, it is useful to have a range of about 0.02 to 0.2 μmol of WO₃ and/or MoO₃ on the electrode.

The electrolyte can either be an acidic or basic solution of water. The fundamental process is the electrolysis of water. The electrolyte is necessary in order to increase the electrical conductivity of pure water. The electrolyte anion must have higher standard electrode potential than hydroxide ion otherwise it will be oxidized instead of the hydroxide, and no oxygen will be produced on the anode. The cation must have lower standard electrode potential than a hydrogen ion otherwise it will be reduced instead of hydrogen, and the cation will deposit on the cathode.

The following cations have lower electrode potential than H′ and therefore can be used as electrolyte cations: Li+, Rb+, K⁺, Cs+, Ba²⁺, Sr²⁺, Ca²⁺, Na+, and Mg²⁺. H₂SO₄ and NaOH pass both criteria and they are suitable electrolytes. Successful tests were carried out with e.g. 1-20 weight % H₂SO₄—H₂O solution. Other useful electrolytes include aqueous solutions of Na₂SO₄ (0.1-10 weight %), Na₂CO₃ (0.1-10 weight %), and NaHCO₃ (0.1-10 weight %). Very strong basic solutions (pH>11) are not suitable, however, because both WO₃ and MoO₃ are soluble in strong basic solutions and the oxide layer would be quickly dissolved.

At pH less than 4, tungsten and tungsten oxide are stable and do not react with the acid, and a thick and solid tungsten oxide layer can be produced on the tungsten tip. Since the dense tungsten oxide layer is a good insulator, the required voltage for deposition was as high as 70V, with 0.1 mA current flowing across a 1 mm² electrode surface.

If the molybdenum part of the electrode assembly is also immersed into the electrolyte, a molybdenum-oxide layer is formed on the molybdenum surface. The molybdenum-oxide layer formed is more porous and therefore more conductive than tungsten-oxide, and much higher current (˜100 mA) can be reached at lower voltage setting (<10V). If both the tungsten tip and the molybdenum part are immersed into the electrolyte, the two metals are connected in parallel electrically. Tungsten-oxide rapidly forms an insulating layer on the tungsten surface and prevents further oxidation of tungsten at the low voltage used for molybdenum oxidation. Therefore even if both metals are immersed at the same time most of the current will flow through the molybdenum part and most of the oxide will be formed on the molybdenum part. This property of the two oxide layers allow us to selectively oxidize either tungsten (by immersing only the tungsten tip) or mostly molybdenum (by immersing both metals). One can also oxidize the tungsten part first to the required oxide thickness then immerse the electrode further into the electrolyte and oxidize the molybdenum part, as well. The thick insulating oxide layer on tungsten will stop any further oxidation of that part.

Both molybdenum and tungsten and their oxides are stable in acid, as it was proved by soaking the oxidized cathodes in the acid overnight. Therefore, quantity of oxide can be measured by the total charge passed through the cell.

Alternatively, a weak alkaline (basic) solution can be used (7<pH<11). Tungsten and tungsten oxide slowly dissolve in basic solution. However, if the oxidation rate is higher than the dissolution rate, an oxide layer can still be created on the electrode. In this case, the oxide film is highly porous as indicated by a much lower required voltage setting for the process. Because of slight dissolution of oxides in a basic solution, the oxide quantity on the electrode depends more on process parameters than when an acidic electrolyte is used.

After the electrochemical oxidation, the electrode is dried in hot air or in vacuum at 200-400 C, so that residual water is removed from the electrode surface and the interstices of the electrode coils. The electrode is then built into the discharge vessel of the metal halide lamp by following the conventional process steps, as described further below.

Other methods of electrode oxidation can be used, such as thermal oxidation and laser oxidation. Thermal oxidation can be achieved in situ or ex situ. Ex situ thermal oxidation can be achieved as follows.

The electrode to be processed is placed in a small vacuum-tight chamber (tube) that is filled with oxygen or an inert gas-oxygen mixture (preferably Ar—O2). The portion of the electrode that is to be oxidized (the tungsten and/or molybdenum portion) is placed inside a heater element (cylinder) and heated to 500-1000 C (preferably to 800 C) for about 30-120 s or until all oxygen in the chamber reacts with the electrode. The quantity of oxidation can be adjusted by adjusting the volume of the chamber, the fill pressure, and the oxygen concentration in the mixture. For example if the chamber volume is 2 cm³ and it is filled to 300 mbar with 5% (oxygen mol %) Ar—O₂ mixture at 25 C then the quantity of elemental oxygen can be calculated as: 2*2 cm³/24789 [cm³/mol]*300 mbar/1000 mbar*0.05=2.4 μmol, where 24789 cm³ is the volume of 1 mol ideal gas at 25 C and standard pressure (1000 mbar).

The parts of the electrode that should not be oxidized (such as the niobium region) can be protected by heat shields. Heater elements can be made of oxygen-resisting materials (kantal) or external infrared heaters can be used if the chamber is made of transparent material (quartz).

Alternatively, only the tungsten electrode tip can be heated locally in an open environment by flame, for example. It is also possible to selectively oxidize the tungsten tip before it is welded to the rest of the electrode assembly. However, this adds unwanted complexity to the electrode manufacturing process since the formerly created tungsten-oxide layer on the electrode tip has to be protected against damage of chemical decomposition through-out the whole electrode assembly manufacturing and cleaning process route.

In situ electrode oxidation can be achieved using the normal arc tube sealing process to oxidize the electrode. The crimped electrode is inserted into the ceramic leg and a seal glass frit ring is placed onto the electrode. This assembly is put into the sealing furnace, pumped to vacuum and flushed with argon a few times. The vacuum furnace is filled with an Ar—O₂ mixture (up to 10 mol % O₂) (the gas mixture fills the arc tube, as well).

The vacuum furnace is flushed with pure Ar without pumping to vacuum. The atmosphere surrounding the arc tube is replaced with Ar, but remains Ar—O₂ inside the arc tube due to slow diffusion through the narrow leg bore. The arc tube is sealed according to the normal sealing process and oxygen oxidizes the electrode inside the arc tube. Nevertheless, since the outer atmosphere is low in oxygen, the furnace heater elements are protected and will not oxidize. The oxygen quantity can be adjusted by Ar—O₂ mixture ratio. For example if the arc tube volume is 0.13 cm³ and it is filled to 300 mbar with 5% (v/v) Ar—O₂ mixture at 25 C then the quantity of elemental oxygen can be calculated as: 2*0.13 cm³/24789 [cm³/mol]*300 mbar/1000 mbar*0.05=0.16 μmol, where 24789 cm³ is the volume of 1 mol ideal gas at 25 C and standard pressure (1000 mbar). The method can be used to oxidize each electrode during their respective sealing process and the quantity of oxygen can be doubled. This process can also be done in a linear (continuous) furnace if it is assembled with an air lock where the atmosphere can be altered.

The electrode can also be oxidized using laser oxidation. In this method, the part of the electrode that is to be oxidized is heated by focused laser beam. Either the electrode or the laser beam should be moved to scan the focus point on the target area in order to prevent electrode melting. The same oxygen-rich atmosphere can be used as for thermal oxidation. The laser oxidation method is best carried out in a fixed volume chamber made of a transparent a heat resistant material (e.g. quartz). The quantity of oxide can be calculated from the chamber volume, the gas pressure and oxygen concentration in the mixture. For example if the chamber volume is 2 cm³ and it is filled to 300 mbar with 5% (oxygen mol %) Ar—O₂ mixture at 25 C then the quantity of elemental oxygen can be calculated as: 2*2 cm³/24789 [cm³/mol]*300 mbar/1000 mbar*0.05=2.4 μmol, where 24789 cm³ is the volume of 1 mol ideal gas at 25 C and standard pressure (1000 mbar).

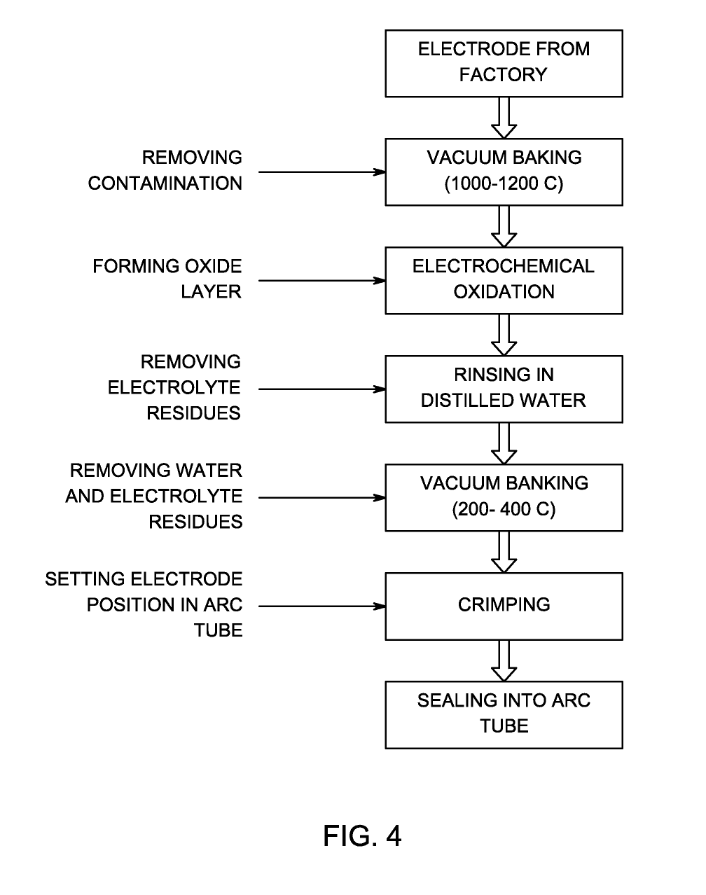

FIG. 4 illustrates a method of making a discharge chamber including an oxygen dosing electrode. After the electrode is obtained it is vacuum baking at 1000-1200 C to remove contaminants. The electrode is then oxidized, such as by electrochemical oxidation as described above. The electrode is rinsed in distilled water to remove electrolyte residues and then crimped to set the electrode position in the arc tube. After another vacuum baking at 200-400 C to remove water and residues, the electrode is sealed into an arc tube.

### EXAMPLE

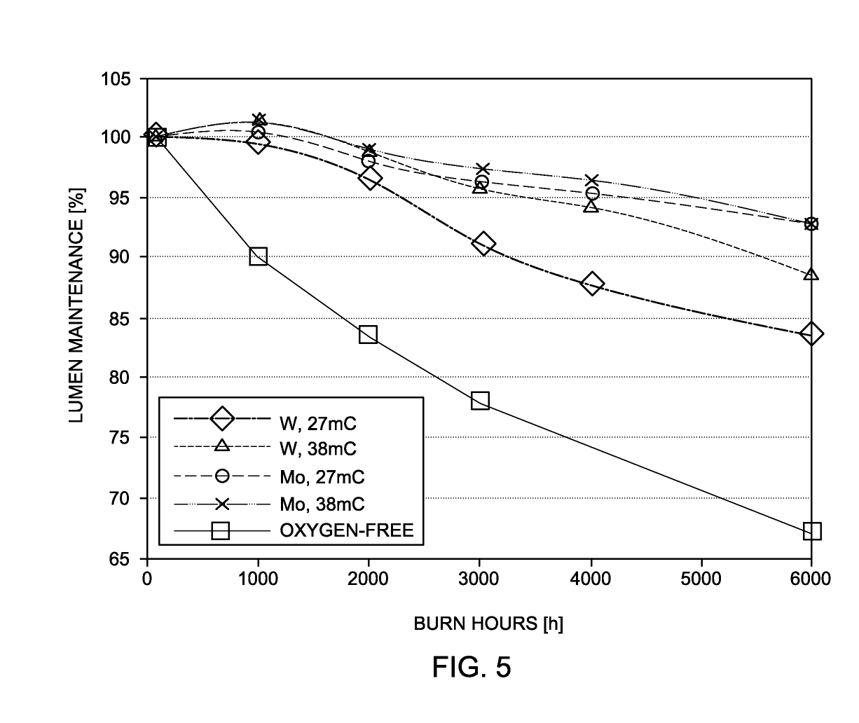

FIG. 5 illustrates the relative lumen maintenance of CMH lamps with electrochemically oxidized electrodes. Experimental lamps were built using the electrochemical electrode oxidation method. The oxidation parameters are summarized in Table 1.

TABLE 1

| | WO₃ | | MoO₃ | |
|---|---|---|---|---|
| Film conductivity | insulating | | conducting | |
| Film morphology | dense | | porous | |
| Substituting diode | ~55 | V | ~1 | V |
| (Voltage on film) | | | | |
| Voltage supply | 80 | V | 5 | V |
| Series resistor | 100K | | 10K | |
| Current | 0.7 mA to 0.1 mA | | 0.4 | mA |
| | decreasing | | constant | |
| Vacuum baking time | 1 | hour | 1 | hour |
| Vacuum baking temperature | 450 | C. | 300 | C. |

In one set of lamps the tungsten tip was immersed in 10% H₂SO₄—H₂O electrolyte along with an auxiliary cathode. 80V voltage was applied to the positive electrode via a 100 KOhm series resistor. The initially 0.7 mA current quickly dropped to 0.1 mA as a thick insulating oxide layer is formed on the tungsten surface. The current was integrated over time and the electrode was removed as soon as the total charge reached the pre-set value. The electrode was then rinsed in distilled water and vacuum baked at 450 C for an hour. In another set of lamps the tungsten tip and about 2 mm of the molybdenum part were immersed in 10% H₂SO₄—H₂O electrolyte along with an auxiliary cathode. 5V voltage was applied to the positive electrode via a 10 KOhm series resistor. The current was constant 0.4 mA throughout the electrode oxidation process indicating a porous, conducting MoO3 layer. The current was integrated over time and the electrode was removed as soon as the total charge reached the pre-set value. The electrode was then rinsed in distilled water and vacuum baked at 300 C for an hour.

39 W CMH Ultra lamps were built using the oxidized electrodes with the W tip or the Mo part oxidized at two charge levels: 27 and 38 mC. Other parameters of the lamps were the same: 5.2 mg Hg and 4.56 mg LaI3-NaI—TlI—CaI2 oxygen-free dose was used. Photometry results of the lamps so prepared are shown in Table 2.

TABLE 2

| | | | | | | | Lumen |
|---|---|---|---|---|---|---|---|
| | | | | | | | Mainte- |
| Oxidized | | Lamp | | | Lumens | Lumens | nance |
| electrode | Charge | Volts | | CCT | [lm] | [lm] | [%] |
| part | [mC] | [V] | CRI | [K] | 100 h | 6000 h | 6000 h |
| W | 27 | 95.1 | 85 | 2977 | 3442 | 2849 | 84 |
| W | 38 | 95.4 | 84 | 3012 | 3410 | 3053 | 89 |
| Mo | 27 | 95.4 | 85 | 2953 | 3541 | 3330 | 93 |
| Mo | 38 | 97.5 | 85 | 2919 | 3500 | 3248 | 93 |
| Oxygen-free | | 93.3 | 85 | 3067 | 3743 | 2507 | 67 |

FIG. 5 also illustrates the lumen maintenance of ceramic metal halide lamps that utilize oxygen dosing from oxidized electrodes. Electrodes having an oxidized molybdenum region are shown with circles (27 mC) and crosses (38 mC); electrodes having an oxidized tungsten tip are shown with diamonds (27 mC) and triangles (38 mC); and the solid line with boxes indicates lamps made with no oxygen dosing. The oxidized electrodes have improved lumen maintenance compared to the oxygen-free lamps. Increasing charge (and therefore increasing oxygen quantity) improves lumen maintenance of the lamps built with oxidized tungsten tip. The best lumen maintenance can be achieved by oxidizing the molybdenum part of the electrode: both 27 and 38 mC total charge results in 93% lumen maintenance at 6000 hours. This fact shows that the molybdenum oxidation method is quite robust and is not sensitive to process variations.

Those skilled in the art will also appreciate that various adaptations and modifications of the preferred and alternative embodiments described above can be configured without departing from the scope and spirit of the disclosure. Therefore, it is to be understood that, within the scope of the appended claims, the disclosure may be practiced other than as specifically described herein.

1. An electrode for dosing oxygen into a metal halide lamp, wherein the electrode comprises a tungsten tip, a molybdenum region, and a niobium leadwire, and wherein either the tungsten tip or the molybdenum region, or both, is oxidized; and
wherein the oxidized portion supplies oxygen during lamp operation in an amount effective to maintain a wall cleaning tungsten halogen chemical cycle.

2. The electrode of claim 1, wherein the oxidized portion supplies oxygen in an amount effective to maintain an oxygen density between 0.5 and 5 μmol oxygen per cm³ arc tube volume.

3. The electrode of claim 1, wherein the amount of oxygen released by the oxidized portion is sufficient to increase the lumen maintenance of the lamp to 80% or higher at 6000 hours.

4. The electrode of claim 1, wherein the oxidized portion contains 0.02 to 0.2 μmol WO₃ and/or MoO₃.

5. The electrode of claim 1, wherein the tungsten tip is electrochemically oxidized.

6. The electrode of claim 1, wherein the molybdenum region is oxidized.

7. The electrode of claim 6 wherein the molybdenum region is electrochemically oxidized.

8. The electrode of claim 6, wherein the molybdenum region is thermally oxidized.

9. The electrode of claim 1, wherein both the tungsten tip and the molybdenum portion are electrochemically oxidized.

10. The electrode of claim 1 wherein the oxidized portion comprises the molybdenum region and the lumen maintenance of the lamp to 90% or higher at 6000 hours.

11. An electrode for dosing oxygen into a metal halide lamp, comprising an oxidized molybdenum overcoil.

12. A method of making an oxidized electrode for use as an oxygen dispenser into the discharge vessel of a metal halide lamp comprising the steps;
placing the electrode to be oxidized in an electrochemical cell containing an electrolyte so that the tungsten tip and molybdenum region are exposed to the electrolyte and passing a current through the electrochemical cell so that WO₃ is formed on the tungsten tip and/or MoO₃ is formed on the molybdenum region.

13. The method of claim 12, wherein the WO₃ formed on the tungsten tip forms an insulating layer.

14. The method of claim 12, wherein the oxidized portion of the electrode contains 0.02 to 0.2 μmol WO₃ and/or MoO₃.

15. The method of claim 12, wherein the oxidized portion of the electrode will supply oxygen in an amount effective to maintain an oxygen density in the discharge vessel between 0.5 and 5 μmol oxygen per cm³ arc tube volume.

16. The method of claim 12, wherein the amount of oxygen released by the oxidized portion of the electrode is sufficient to increase the lumen maintenance of the lamp to 80% or higher at 6000 hours.

17. The method of claim 12, wherein the total charge required to produce a predetermined oxygen quantity on the electrode can be calculated from Faraday's law as Q[C]=F*n(O) [mol], where F (the Faraday constant) is 96485 C/mol and n(O) is the predetermined elemental oxygen quantity.

18. The method of claim 12 where the molybdenum region of the electrode is oxidized and wherein the amount of oxygen released by the oxidized portion of the electrode is sufficient to increase the lumen maintenance of the lamp to 90% or higher at 6000 hours.

19. The method of claim 12 wherein the electrolyte is a 1-20% solution of H₂SO₄, Na₂SO₄, Na₂CO₃, or NaHCO₃.

20. The method of claim 12 wherein the electrolyte is a 1-20% solution of H₂SO₄.
